(19) United States
(12) Patent Application Publication
(10) Pub. No.: US 2025/0225625 A1
(43) Pub. Date: Jul. 10, 2025

(54) VIDEO PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Dingdong YANG, Beijing (CN); Kaixiang LEI, Beijing (CN); Chunji YIN, Beijing (CN)

(21) Appl. No.: 18/849,994

(22) PCT Filed: Mar. 8, 2023
(86) PCT No.: PCT/CN2023/080197

§ 371 Date: Sep. 23, 2024

(30) Foreign Application Priority Data
Mar. 24, 2022 (CN) 202210303579.3

(51) Int. Cl. G06T 5/70; G06T 3/4007; G06T 3/4046; G06T 5/20; G06T 5/50; G06T 5/60

(52) U.S. Cl. CPC G06T 5/70; G06T 3/4007; G06T 3/4046; G06T 5/20; G06T 5/50; G06T 5/60; G06T 2207/10016; G06T 2207/20081; G06T 2207/20084

(57) ABSTRACT

A video processing method, an electronic device, and a non-transitory storage medium are provided. The video processing method includes: acquiring a video frame to be processed; inputting the video frame to be processed into an image processing model to obtain a target video frame corresponding to the video frame to be processed; and obtaining a target video by splicing a plurality of target video frames. The image processing model includes an anti-aliasing operator for processing the video frame to be processed, and the anti-aliasing operator includes an anti-aliasing up-sampling operator, an anti-aliasing nonlinear operator, and an anti-aliasing down-sampling operator.

This application claims the priority to and benefits of China Patent Application No. 202210303579.3, filed on Mar. 24, 2022, the entire content of which is incorporated into this application by reference.

### TECHNICAL FIELD

The present disclosure relates to the technical field of image processing, for example, a video processing method and apparatus, an electronic device, and a storage medium.

### BACKGROUND

With the continuous advancement of network technologies, an increasing number of applications have permeated users' daily lives, especially a series of software capturing short videos, which are highly favored by the users.

In the related art, application software can provide users with the function of video processing, which can be understood as integrating a variety of models constructed previously into the application, processing a video based on the variety of models, and then obtaining corresponding processing results, so that a video image is presented in a specific style, color, and etc., for example.

However, in response to processing a video, when the adjacent frames are greatly changed (for example, the image is slightly displaced or rotated), the processed video frames output by the model will be greatly changed, so that the processed video presents the visual effect of “dithering”. Using the aforementioned method not only fails to effectively solve the issue of image dithering, but also diminishes the quality and clarity of the images, thereby impairing the user experience.

### SUMMARY

The present disclosure provides a video processing method and apparatus, an electronic device, and a storage medium, which can effectively avoid the “dithering” of the output video image when the adjacent frames of an original video are greatly changed, and solve the issue of picture “dithering” without reducing the quality and clarity of the image, thereby improving the user experience.

In the first aspect, the present disclosure provides a video processing method, which includes:
acquiring a video frame to be processed;
inputting the video frame to be processed into an image processing model to obtain a target video frame corresponding to the video frame to be processed, in which the image processing model includes an anti-aliasing operator for processing the video frame to be processed, and the anti-aliasing operator includes an anti-aliasing up-sampling operator, an anti-aliasing nonlinear operator, and an anti-aliasing down-sampling operator; and
obtaining a target video by splicing a plurality of target video frames.

In the second aspect, the present disclosure also provides a video processing apparatus, which includes a video frame to be processed acquiring module, a target video frame determining module, and a target video generating module.

The video frame to be processed acquiring module is configured to acquire a video frame to be processed.

The target video frame determining module is configured to input the video frame to be processed into an image processing model to obtain a target video frame corresponding to the video frame to be processed, in which the image processing model includes an anti-aliasing operator for processing the video frame to be processed, and the anti-aliasing operator includes an anti-aliasing up-sampling operator, an anti-aliasing nonlinear operator, and an anti-aliasing down-sampling operator.

The target video generating module is configured to obtain a target video by splicing a plurality of target video frames.

In the third aspect, the present disclosure also provides an electronic device, which includes: at least one processor, and a storage apparatus which is configured to store at least one program.

When the at least one program is executed by the at least one processor, the at least one processor performs the above video processing method.

In the fourth aspect, the present disclosure also provides a storage medium, which includes computer-executable instructions. When executed by a computer processor, the computer-executable instructions are used to perform the above video processing method.

In the fifth aspect, the present disclosure also provides a computer program product, which includes a computer program carried on a non-transitory computer-readable medium. The computer program includes program code for executing the above video processing method.

### BRIEF DESCRIPTION OF DRAWINGS

FIG. 1 is a flowchart of a video processing method provided by the first embodiment of the present disclosure;

FIG. 2 is a schematic structural diagram of an anti-aliasing operator provided by the first embodiment of the present disclosure;

FIG. 3 is a flow diagram of a video processing method provided by the second embodiment of the present disclosure;

FIG. 4 is a schematic structural diagram of a video processing apparatus provided by the third embodiment of the present disclosure; and

FIG. 5 is a schematic structural diagram of an electronic device provided by the fourth embodiment of the present disclosure.

### DETAILED DESCRIPTION

The embodiments of the present disclosure are be described below with reference to the drawings. Although some embodiments of the present disclosure are illustrated in the drawings, the present disclosure can be implemented in various forms. These embodiments are provided for understanding the present disclosure. The drawings and embodiments of the present disclosure are only used for an illustrative purpose.

The plurality of steps described in the method embodiments of the present disclosure may be performed in a different order and/or in parallel. Furthermore, the method embodiments may include additional steps and/or omit performing the illustrated steps. The scope of the present disclosure is not limited in this respect.

As used herein, the term “include/including/comprise/comprising” and its variants are open-ended including, that is, “including but not limited to”. The term “based on” indicates “at least partially based on”. The term “one/an embodiment” indicates “at least one embodiment”; The term “another embodiment” indicates “at least one other embodiment”; The term “some embodiments” indicates “at least some embodiments”. Related definitions of other terms are given in the following description.

The concepts of “first” and “second” in the present disclosure are only used to distinguish different devices, modules, or units, and not used to limit the order or interdependence of the functions performed by these devices, modules or units. The modifications of “a/one” and “a plurality of” in the present disclosure are schematic rather than limiting, and those skilled in the art should understand that they should be understood as “one or more”, unless indicated in the context otherwise.

### First Embodiment

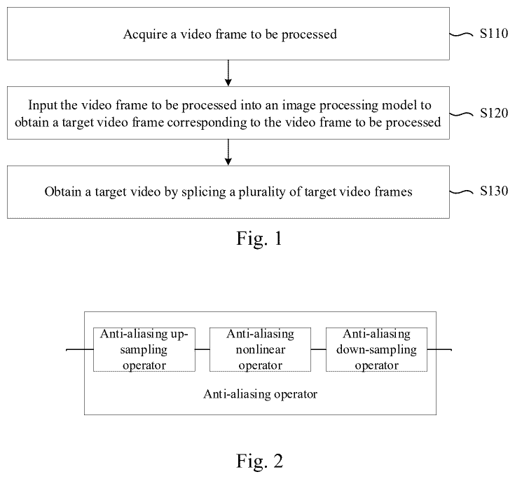

FIG. 1 is a flow chart of a video processing method provided by the first embodiment of the present disclosure. The embodiment of the present disclosure is applicable for processing the acquired video frame to be processed based on the image processing model including an anti-aliasing operator, so as to avoid the “dithering” of the output video. The method can be implemented by a video processing apparatus, which can be implemented in the form of software and/or hardware, for example, by an electronic device. The electronic device may be a mobile terminal, a personal computer terminal or a server.

Before introducing the technical scheme, the application scenario of the embodiment of the present disclosure is described here. When generating the corresponding target video based on the video to be processed, there are usually three solutions. The first solution is to input multiple video frames into a neural network at the same time for train and inference. Because it is required to store the image data of the previous frames, this method seriously increases the resource overhead and delay in the inference, and fails to be applied to a mobile terminal in real time, and the image dithering still exists. The second solution is mainly to blur the input image, which not only fails to solve the issue of dithering, but also introduces blurring to the output image, significantly reducing the clarity of the output image and resulting in a substantial degradation of visual quality and texture of the output image. The third solution is mainly to enhance the input data and output data when training the pix2pix network in order to imitate the dithering, expecting to make the network adapt to the dithering of the input picture. However, from the pictures actually obtained, there are still a lot of dithering issues in the pictures. Based on the above, it can be seen that the above data processing method still has the problem of serious dithering in the output image. In this case, according to the technical scheme of the embodiment of the present disclosure, i.e., processing the acquired video frame to be processed based on the image processing model including the anti-aliasing operator, the dithering of the output video can be avoided.

As illustrated in FIG. 1, the method includes:

S110: acquiring a video frame to be processed.

An apparatus for performing the video processing method provided by the embodiment of the present disclosure may be integrated into application software supporting the video processing function, and the software may be installed in an electronic device, and the electronic device may be a mobile terminal or a PC terminal. The application software may be a kind of software for image/video processing, which is not detailed here, as long as the image/video processing can be implemented. The application software may also be an application specially developed to perform the video processing and display the output video, or the application software may be integrated in a corresponding interface, and users can process a specific video through the integrated interface in the PC.

In this embodiment, a user can capture a video in real time based on a camera apparatus of a mobile terminal, or upload the video actively based on a pre-developed control in the application, the video captured in real time and obtained by the application or the video actively uploaded by the user is the video to be processed. Based on pre-written programs, the video to be processed is parsed, and a plurality of video frames to be processed can be obtained. It should be understood by the skilled in the art that when the capturing angle of the camera apparatus shifts or rotates in a short time during the process of capturing a video by a user, after the video is processed by a traditional image processing model, several corresponding video images present the effect of “dithering”, and the quality and clarity of the obtained images are not desired.

S120: inputting the video frame to be processed into an image processing model to obtain a target video frame corresponding to the video frame to be processed.

When the video frame to be processed is processed through a convolution layer, the solution adopted by the related art leads to the spread of the image spectrum, thus leading to the visual effect of “dithering” in the video output finally. The processing process of the embodiment of the present disclosure is to: firstly, determine an anti-aliasing up-sampling operator, an anti-aliasing nonlinear operator, and an anti-aliasing down-sampling operator, and then determine an anti-aliasing operator based on the above mappings; finally, integrate the anti-aliasing operator into an image processing model and train the image processing model. After the image processing model is trained, the input image can be processed by using the image processing model. In this process, the image processing model containing the anti-aliasing operator does not lead to the spread of the image spectrum, thus ensuring the quality and clarity of the output image.

In this embodiment, after the application obtains a plurality of video frames to be processed, each video frame to be processed is input into the image processing model. The image processing model may be a pre-trained neural network model, for example, a bandwidth-strict neural network. In order to introduce the image processing process of the present disclosure, the bandwidth-strict pixel-to-pixel neural network introduced by the embodiment of the present disclosure is described below.

In this embodiment, the pixel-to-pixel network pixel2pixel is abbreviated as pix2pix. This technology is a style conversion and image generation technology. After an image is input to the neural network, the neural network outputs an image accordingly, and the image output by the model can meet the expectations of users, for example, changing the real characters in the input image to a cartoon style, or a painting style, or changing the color and brightness of the image, and the like.

In order to solve the problem that the output video picture may appear “dithering”, the image processing model at least includes an anti-aliasing operator for processing the video frame to be processed, and the anti-aliasing operator includes an anti-aliasing up-sampling operator, an anti-aliasing nonlinear operator, and an anti-aliasing down-sampling operator. An operator is a mapping from one function space to another function space in the model, and any operation on any function in the model may be considered as an operator. In this embodiment, the anti-aliasing up-sampling operator is the operator corresponding to the operation of collecting samples of an analog signal. Based on the anti-aliasing up-sampling operator, the signal that is continuous in time and amplitude can be converted into the signal that is discrete in time and amplitude under the action of the sampling pulse, thus the up-sampling process is also called the waveform discretization process. The anti-aliasing down-sampling operator is the operator corresponding to the operation of sampling a sample sequence every few samples and getting a new sequence, which is a process of extraction. The anti-aliasing nonlinear operator is also called a nonlinear mapping, that is, an operator that does not satisfy linear conditions.

In this embodiment, bandwidth-strict means that the operator in the model has a strict bandwidth limitation on the spectrum, that is, when s represents the sampling frequency of the video frame to be processed as input, no frequency exceeding half of the sampling frequency (s/2) is introduced. Accordingly, the anti-aliasing representation is equivalent to the above bandwidth requirements, that is, only when the frequency of the continuous signal does not exceed half of the sampling frequency, the sampled signals can be restored to the real signal to achieve anti-aliasing, and otherwise, the aliasing occurs.

Based on the above, the anti-aliasing up-sampling operator, the anti-aliasing nonlinear operator, and the anti-aliasing down-sampling operator may be spliced and integrated to obtain the anti-aliasing operator, and the anti-aliasing operator may be introduced into the image processing model of the embodiment of the present disclosure. In the process of generating the target video frame based on the image processing model, when the video frame to be processed is processed based on the image processing model, the video frame to be processed is sequentially processed based on the anti-aliasing up-sampling operator, the anti-aliasing nonlinear operator, and the anti-aliasing down-sampling operator in the anti-aliasing operators, so as to obtain the target video frame having the target effect.

Combining with FIG. 2, it can be seen that when the video frame to be processed is processed, the corresponding tensor information is input to the anti-aliasing up-sampling operator for processing, then the processing result of the anti-aliasing up-sampling operator is input to the anti-aliasing nonlinear operator for processing, and finally the processing result of the anti-aliasing nonlinear operator is input to the anti-aliasing down-sampling operator for processing, so that the target video frame corresponding to the video frame to be processed is obtained. This process is the process of processing the video frame to be processed based on the image processing model containing the anti-aliasing operator. The network layers connected to the anti-aliasing operator may include various types of layers, which is not specifically limited by the embodiments of the present disclosure.

When detecting that the video frame to be processed is processed, the current tensor information corresponding to the video frame to be processed is taken as the input of the anti-aliasing up-sampling operator, and the current tensor information is interpolated based on the anti-aliasing up-sampling operator to obtain the first preprocessing tensor; spreading the signal spectrum corresponding to the first preprocessing tensor by at least two times based on the anti-aliasing nonlinear operator to obtain the target signal spectrum corresponding to the first preprocessing image; and based on the anti-aliasing down-sampling operator, the target signal spectrum is down-sampled and the down-sampling frequency is controlled to be a preset value of the original sampling frequency.

The sampling frequency is the size of the current image (that is, the current operation result). For example, when the side length of a square is L, the application may determine that the sampling frequency is L, and correspondingly, the cut-off frequency is the frequency that the information contained in the image can reach. Taking the above square as an example, the cut-off frequency should be less than L/2 in the case where the bandwidth of the embodiment is strictly limited without aliasing. The tensor is the multiple linear mapping defined on Cartesian products of some vector spaces and some dual spaces, in which each component is a function of coordinates, and the components are linearly transformed according to some rules when the coordinates are transformed. Therefore, for each video frame to be processed in the embodiment of the present disclosure, the tensor, as a geometric entity, may include a scalar, vector, and current operator, and may be expressed by a coordinate system. Next, taking the processing process of a video frame to be processed corresponding to the current time point as an example for explaining.

In this embodiment, after the tensor information of the video frame to be processed at the current time point is determined by the application, the tensor information is input into the image processing model and processed by the anti-aliasing up-sampling operator, thereby the first preprocessing tensor is obtained. The current tensor information is zero-inserted in the spatial dimension to obtain the tensor information to be processed. Based on the convolution kernel constructed by an interpolation function, the tensor information to be processed is interpolated to obtain the first preprocessing tensor. For example, based on the anti-aliasing up-sampling operator, 0 may be inserted at intervals in the spatial dimension, and then an ideal interpolation function is used to perform the interpolation operation, where the interpolation function is

$$sin c ( x ) = \frac{sin ( π x )}{π x} .$$

Finally, the tensor information obtained after the zero-inserting operation is convolution-processed by using the convolution kernel constructed by the sinc function, and then the first preprocessing tensor is obtained.

The first preprocessing tensor may be used as an input and processed by the anti-aliasing nonlinear operator in the image processing model, so as to obtain the target signal spectrum corresponding to the first preprocessing tensor. The target signal spectrum is the abbreviation of the target signal frequency spectral density, which may be a frequency distribution curve. The signal spectrum corresponding to the first preprocessing tensor may be spread by at least two times based on the anti-aliasing nonlinear operator in the image processing model, thus the operator of up-sampling twice may be used to perform the nonlinear operation element by element, and finally the image can be restored to its original size through down-sampling processing.

Finally, after obtaining the target signal spectrum, the target signal spectrum may be used as input and down-sampled by the anti-aliasing down-sampling operator, and the down-sampling frequency is controlled to be a preset value of the original sampling frequency. The original sampling frequency is consistent with the sampling frequency of the current tensor, and the preset value corresponds to the spreading factor of the signal spectrum. Because the anti-aliasing down-sampling operator reduces the sampling frequency by two times, thus in this embodiment, it is also necessary to introduce an operator with a bandwidth of one quarter of the original sampling frequency into the image processing model. Meanwhile, in order to maintain the rotation invariance, the convolution kernel corresponding to the down-sampling operator may be constructed in advance by using the jinc function. The bandwidth-limited down-sampling is implemented by eliminating the corresponding features at intervals in the spatial dimension after convolution on the input image of the original size.

In this embodiment, after processing the tensor information corresponding to the video frame to be processed based on multiple operators in the image processing model, the corresponding target video frame is obtained. The processing mode of the embodiment of the present disclosure can at least make the image present a specific target effect, and the target effect is consistent with the non-dithering effect. For example, when the pictures of consecutive frames in the video frames to be processed change greatly, the corresponding consecutive video frames output by the image processing model do not present the visual effect of “dithering”, which is consistent with the non-dithering effect.

Although the above description is aimed at the processing process of one video frame to be processed, those skilled in the art should understand that other video frames to be processed may also be input into the image processing model for processing in the above manner according to the embodiment of the present disclosure, so as to obtain a plurality of corresponding target video frames, which is not repeated here.

S130: obtaining a target video by splicing a plurality of target video frames.

In this embodiment, because each target video frame has the same time stamp with the corresponding video frame to be processed, thus, after the image processing model processes each video frame to be processed and outputs the corresponding target video frame, the application may splice the plurality of images according to the time stamp corresponding to each target video frame, thus obtaining the target video. By splicing the plurality of frames of pictures and generating the target video, the processed pictures can be displayed in a non-dithering and coherent manner.

After the target video is determined by the application, the video may be directly played to display the processed video pictures on the display interface, or the target video may be stored in a specific space according to a preset path, which is not limited by the embodiment of the present disclosure.

According to the technical scheme of the embodiment of the disclosure, a video frame to be processed is obtained, and then the video frame to be processed is input into an image processing model including an anti-aliasing operator to obtain a target video frame corresponding to the video frame to be processed. The anti-aliasing operator includes an anti-aliasing up-sampling operator, an anti-aliasing nonlinear operator, and an anti-aliasing down-sampling operator. The target video is obtained by splicing the plurality of target video frames. When the adjacent frames of the original video change greatly, the “dithering” of the output video picture can be effectively avoided, the issue of picture “dithering” can be solved without reducing the quality and clarity of the image, thereby improving the user experience.

### Second Embodiment

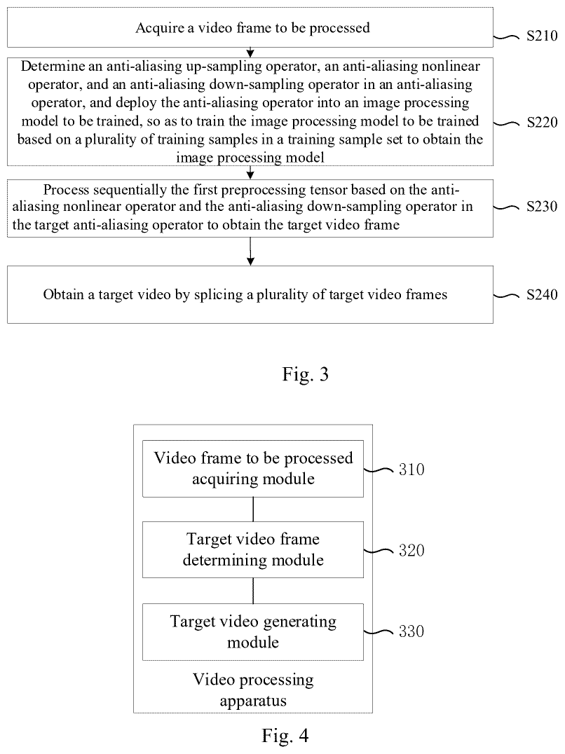

FIG. 3 is a schematic flow chart of a video processing method provided by the second embodiment of the present disclosure. On the basis of the aforementioned embodiment, by optimizing the anti-aliasing up-sampling operator in the anti-aliasing operator, the obtained target anti-aliasing operator is deployed to the image processing model to be trained, and the model is trained, which not only avoids the occurrence of “dithering” in the video processing process, but also reduces the overhead of computing resources and facilitates to deploy the model into a mobile terminal. Meanwhile, the neural network operator is low-pass transformed in terms of frequency, which reduces the number of convolution kernels and makes the model more universal. Implementations thereof may refer to the technical scheme of this embodiment. The technical terms that are the same as or corresponding to the above embodiments are not repeated here.

As illustrated in FIG. 3, the method includes the following steps:

S210: acquiring a video frame to be processed.

S220: determining an anti-aliasing up-sampling operator, an anti-aliasing nonlinear operator, and an anti-aliasing down-sampling operator in an anti-aliasing operator, and deploying the anti-aliasing operator into an image processing model to be trained, so as to train the image processing model to be trained based on a plurality of training samples in a training sample set to obtain the image processing model.

In this embodiment, before processing the video frame to be processed based on the image processing model, the application firstly determines the pre-built anti-aliasing up-sampling operator, anti-aliasing nonlinear operator, and anti-aliasing down-sampling operator, obtains the anti-aliasing operator by splicing these operators according to the architecture designed by the staff in advance, and deploys the anti-aliasing operator into the image training model. The process is described below.

The anti-aliasing up-sampling operator in the anti-aliasing operator is optimized, and the anti-aliasing nonlinear operator and the anti-aliasing down-sampling operator are maintained unchanged to obtain the target anti-aliasing operator, and the target anti-aliasing operator is deployed in the image processing model to be trained.

In the process of determining the target anti-aliasing operator, the convolution kernels to be used may be determined based on the original sampling frequency, the cut-off frequency corresponding to the anti-aliasing down-sampling operator, the filtering frequency corresponding to a filter, the interpolation function, and the width of a preset window. Two convolution kernels to be applied are determined by separating the convolution kernels to be used. The anti-aliasing up-sampling operator is determined based on the two convolution kernels to be applied.

In this embodiment, in addition to the original sampling frequency corresponding to the video frame to be processed, the application also needs to determine the shape of the spectrogram of a filter. It is required to determine two parameters corresponding to the filter, w_c and w_s, where w_c is the cut-off frequency, i.e., the frequency that the filter allows to pass effectively, and w_s determines the length of the transition band. The length of the transition band indicates the performance and accuracy of the filter. In the actual process of designing the filter, it is also necessary to pre-deploy a window, for example, the Kaiser window, whose width can be represented by N. It should be understood by those skilled in the art that the Kaiser window is a locally optimized window function having strong capability, which is realized by using a modified zero-order Bessel function, which is not described in detail in the embodiment of the present disclosure.

Based on the above parameters, the application can determine the convolution kernel to be used. It should be understood by those skilled in the art that during the image processing, given an input image, pixels in a small region in the input image are weighted and summed to become each corresponding pixel in the output image, in which the weights are defined by a function, and the function is the convolution kernel. In this embodiment, there may be one or more convolution kernels to be used, at least for processing the tensor corresponding to the video frame to be processed, and the convolution kernels to be used also include a plurality of values to be used.

In this embodiment, if only a single up-sampling process is deployed, 0 is inserted at intervals in the spatial dimension, and then the convolution processing is performed by using the separable convolution (1×N′, N′×1, N′=N*2) in the x and y directions. If the input tensor is denoted as x, the amount of calculation is x·nelement ( )*4*(N′+N′), however, if 1×N′, N′×1 is not optimized, it is adverse to data storage and access, and the actual running speed of the model is slow. Therefore, in this embodiment, the convolution kernel to be used may be split into two convolution kernels to be applied, and then the anti-aliasing up-sampling operator may be determined based on the two convolution kernels to be applied. For example, the application may split the convolution kernel to be used into s1=[k₁, k₃, k₅, k₇, . . . , k_{N′-}1] and s2=[k₂, k₄, k₆, k₈, . . . , k_{N′}], so as to obtain the two convolution kernels to be applied.

At least four convolution kernels to be deployed are obtained by combining the two convolution kernels to be applied, and the at least four convolution kernels to be deployed are determined as the anti-aliasing up-sampling operator. Continuing to explain with the above example, after obtaining the two convolution kernels to be applied, i.e., s1 and s2, four N×N convolution kernels may be constructed based on the two convolution kernels, so as to implement the N×N convolution processing on the video frame to be processed with the original size. In this process, it is not required to insert 0 at intervals in the spatial dimension. The first preprocessing tensor is obtained by processing the current tensor information corresponding to the video frame to be processed based on at least four convolution kernels to be deployed in the anti-aliasing up-sampling operator. For example, the operation of determining the anti-aliasing up-sampling operator and obtaining the corresponding first preprocessing tensor can be completed by performing the “concat” processing on the result and executing the PixelShuffle method. Those skilled in the art should understand that the PixelShuffle method can effectively enlarge the reduced feature map, and can replace the interpolation or deconvolution method for upscale.

When the video frame to be processed is processed, the up-sampling process in the embodiment of the present disclosure may be implemented based on the four convolution kernels to be deployed in the image processing model, and then the processing result is input to the anti-aliasing nonlinear operator, and the subsequent image processing process is performed according to the method of the first embodiment of the present disclosure.

Finally, the image processing model to be trained is trained based on the training sample set to obtain the image processing model, so as to deploy the image processing model to the terminal device having computing power less than the preset computing power threshold. The training sample set may be data including the input image and corresponding output image. In the process of training the image processing model to be trained, the loss processing may be performed on the picture data based on the loss function corresponding to the model, so as to correct the model parameters in the image processing model to be trained according to a plurality of loss values which are obtained. Meanwhile, the convergence of the loss function is taken as the training target, and the trained image processing model can be obtained.

After the image processing model to be trained processes a plurality of images as input in the training set and obtains the corresponding output, a plurality of corresponding loss values are determined based on the output and the images as output in the training set. When the model parameters are corrected by using the plurality of loss values and the loss function, the training error of the loss function, i.e., the loss parameter is taken as a condition to detect whether the loss function is converging currently, such as, whether the training error is less than the preset error or whether the error change trend tends to be stable, or whether the current iteration number is equal to the preset number. If it is detected that the convergence condition is met, for example, the training error of the loss function is less than the preset error, or the error change trend tends to be stable, which indicates that the training of the image processing model to be trained is completed, the iterative training may be stopped right now. If it is detected that the current convergence condition is not met, other training sets may be obtained to continue training the model until the training error of the loss function is within the preset range. When the training error of the loss function reaches the convergence, the image processing model to be trained which completes training is used as the image processing model to be used and deployed to the application.

S230: sequentially processing the first preprocessing tensor based on the anti-aliasing nonlinear operator and the anti-aliasing down-sampling operator in the target anti-aliasing operator to obtain the target video frame.

S240: obtaining a target video by splicing a plurality of target video frames.

For the technical scheme of this embodiment, by optimizing the anti-aliasing up-sampling operator in the anti-aliasing operator, the obtained target anti-aliasing operator is deployed to the image processing model to be trained, and the model is trained, which not only avoids the occurrence of “dithering” in the video processing process, but also reduces the overhead of computing resources and facilitates to deploy the model into a mobile terminal. Meanwhile, the neural network operator is low-pass transformed in terms of frequency, which reduces the number of convolution kernels and makes the model more universal.

### Third Embodiment

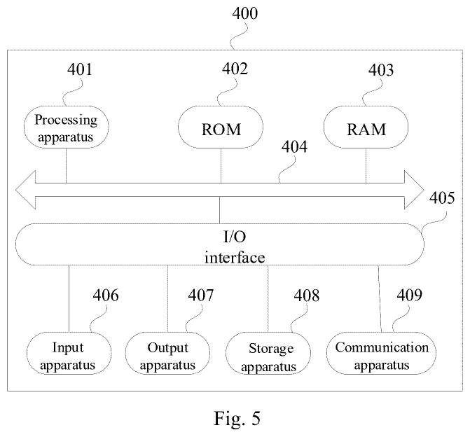

FIG. 4 is a schematic structural diagram of a video processing apparatus provided by the third embodiment of the present disclosure, as illustrated in FIG. 4. The video processing apparatus includes a video frame to be processed acquiring module 310, a target video frame determining module 320, and a target video generating module 330.

The video frame to be processed acquiring module 310 is configured to acquire a video frame to be processed.

The target video frame determining module 320 is configured to input the video frame to be processed into an image processing model to obtain a target video frame corresponding to the video frame to be processed, in which the image processing model includes an anti-aliasing operator for processing the video frame to be processed, and the anti-aliasing operator includes an anti-aliasing up-sampling operator, an anti-aliasing nonlinear operator, and an anti-aliasing down-sampling operator.

The target video generating module 330 is configured to obtain a target video by splicing a plurality of target video frames.

Based on the above technical schemes, the target video frame determining module 320 is further configured to: when the video frame to be processed is non-linearly processed based on the image processing model, sequentially process the video frame to be processed based on the anti-aliasing up-sampling operator, the anti-aliasing nonlinear operator, and the anti-aliasing down-sampling operator in the anti-aliasing operators to obtain a target video frame having a target effect. The target effect is consistent with the non-dithering effect.

Based on the above technical schemes, the target video frame determining module 320 includes the first preprocessing tensor determining unit, a target signal spectrum determining unit, and a down-sampling processing unit.

The first preprocessing tensor determining unit is configured to: in response to detecting that the video frame to be processed is non-linearly processed, determine current tensor information corresponding to the video frame to be processed as an input to the anti-aliasing up-sampling operator, and interpolate the current tensor information based on the anti-aliasing up-sampling operator to obtain the first preprocessing tensor.

The target signal spectrum determining unit is configured to spread the signal spectrum corresponding to the first preprocessing tensor by at least two times based on the anti-aliasing nonlinear operator to obtain the target signal spectrum corresponding to the first preprocessing image.

The down-sampling processing unit is configured to down-sample the target signal spectrum based on the anti-aliasing down-sampling operator, and control a down-sampling frequency to be a preset value of an original sampling frequency. The original sampling frequency is consistent with a sampling frequency of the current tensor, and the preset value corresponds to a spreading factor of the signal spectrum.

Based on the above technical schemes, the first preprocessing tensor determining unit is further configured to zero-insert the current tensor information in a spatial dimension to obtain tensor information to be processed, and interpolate the tensor information to be processed based on a convolution kernel constructed by an interpolation function to obtain the first preprocessing tensor.

Based on the above technical schemes, the video processing apparatus also includes a model training module.

The model training module is configured to determine the anti-aliasing up-sampling operator, the anti-aliasing nonlinear operator, and the anti-aliasing down-sampling operator in the anti-aliasing operators, and deploy the anti-aliasing operators into an image processing model to be trained, in order to train the image processing model to be trained based on a plurality of training samples in a training sample set to obtain the image processing model.

Based on the above technical schemes, the video processing apparatus also includes a target anti-aliasing operator determining module and an image processing model determining module.

The target anti-aliasing operator determining module is configured to optimize the anti-aliasing up-sampling operator in the anti-aliasing operator and maintain the anti-aliasing nonlinear operator and the anti-aliasing down-sampling operator unchanged to obtain a target anti-aliasing operator, and deploy the target anti-aliasing operator in the image processing model to be trained.

The image processing model determining module is configured to train the image processing model to be trained based on the training sample set to obtain the image processing model, in order to deploy the image processing model to a terminal device having computational power less than a preset computational power threshold.

Based on the above technical schemes, the target anti-aliasing operator determining module includes a convolution kernel to be used determining unit, a convolution kernel to be applied determining unit, and an anti-aliasing up-sampling operator determining unit.

The convolution kernel to be used determining unit is configured to determine convolution kernels to be used based on an original sampling frequency, a cut-off frequency corresponding to the anti-aliasing down-sampling operator, a filtering frequency corresponding to a filter, an interpolation function, and a width of a preset window. The convolution kernels to be used include a plurality of values to be used.

The convolution kernel to be applied determining unit is configured to determine two convolution kernels to be applied by separating the convolution kernels to be used.

The anti-aliasing up-sampling operator determining unit is configured to determine the anti-aliasing up-sampling operator based on the two convolution kernels to be applied.

Based on the above technical schemes, the anti-aliasing up-sampling operator determining unit is further configured to obtain at least four convolution kernels to be deployed by combining the two convolution kernels to be applied, and determine the at least four convolution kernels to be deployed as the anti-aliasing up-sampling operator.

Based on the above technical schemes, the target video frame determining module 320 is further configured to process current tensor information corresponding to the video frame to be processed based on the at least four convolution kernels to be deployed in the anti-aliasing up-sampling operator to obtain the first preprocessing tensor; and sequentially process the first preprocessing tensor based on the anti-aliasing nonlinear operator and the anti-aliasing down-sampling operator in the target anti-aliasing operator.

According to the technical schemes provided by this embodiment, a video frame to be processed is obtained, and then the video frame to be processed is input into an image processing model including an anti-aliasing operator to obtain a target video frame corresponding to the video frame to be processed. The anti-aliasing operator includes an anti-aliasing up-sampling operator, an anti-aliasing nonlinear operator, and an anti-aliasing down-sampling operator. The target video is obtained by splicing the plurality of target video frames. When the adjacent frames of the original video change greatly, the “dithering” of the output video picture can be effectively avoided, the issue of picture “dithering” can be solved without reducing the quality and clarity of the image, thereby improving the user experience.

The video processing apparatus provided by the embodiment of the present disclosure may execute the video processing method provided by any embodiment of the present disclosure, and has corresponding functional modules and effects.

The multiple units and modules included in the above apparatus are divided according to the functional logic, which may not be limited to the above division, as long as the corresponding functions can be implemented. In addition, the names of the multiple functional units are only for the convenience of distinguishing each other, and are not used to limit the protection scope of the disclosed embodiments.

### Fourth Embodiment

FIG. 5 is a schematic structural diagram of an electronic device provided in the fourth embodiment of the present disclosure. Referring to FIG. 5, FIG. 5 illustrates a schematic structural diagram of an electronic device 400 (e.g., the terminal device and server in FIG. 5) suitable for implementing the embodiments of the present disclosure. The electronic device in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device 400 illustrated in FIG. 5 is merely an example, and should not pose any limitation to the functions and the range of use of the embodiments of the present disclosure.

As illustrated in FIG. 5, the electronic device 400 may include a processing apparatus 401 (e.g., a central processing unit, a graphics processing unit, etc.), which can perform multiple suitable actions and processing according to a program stored in a read-only memory (ROM) 402 or a program loaded from a storage apparatus 408 into a random-access memory (RAM) 403. The RAM 403 further stores multiple programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a storage apparatus 408 including, for example, a magnetic tape, a hard disk, or the like; and a communication apparatus 409. The communication apparatus 409 may allow the electronic device 400 to be in wireless or wired communication with other devices to exchange data. While FIG. 5 illustrates the electronic device 400 having multiple apparatuses, not all of the illustrated apparatuses are necessarily implemented or included. More or fewer apparatuses may be implemented or included alternatively.

According to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the storage apparatus 408, or may be installed from the ROM 402. When the computer program is executed by the processing apparatus 401, the above-mentioned functions defined in the methods of some embodiments of the present disclosure are performed.

Names of messages or information exchanged among multiple apparatuses in the embodiments of the present disclosure are only used for illustrative purposes, and are not used to limit the scope of these messages or information.

The electronic device provided by the embodiment of the present disclosure belongs to the same inventive concept as the video processing method provided by the above embodiment, and the technical details which are not described in detail in this embodiment can be found in the above embodiments, and this embodiment has the same effects as the above embodiments.

### Fifth Embodiment

An embodiment of the present disclosure provides a computer storage medium on which a computer program is stored. When the computer program is executed by a processor, the video processing method provided in the above embodiments is performed.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. Examples of the computer-readable storage medium may include but not be limited to: an electrical connection with one or more wires, a portable computer disk, a hard disk, a RAM, a ROM, an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
acquire a video frame to be processed, input the video frame to be processed into an image processing model to obtain a target video frame corresponding to the video frame to be processed, and obtain a target video by splicing a plurality of target video frames. The image processing model includes an anti-aliasing operator for processing the video frame to be processed, and the anti-aliasing operator includes an anti-aliasing up-sampling operator, an anti-aliasing nonlinear operator, and an anti-aliasing down-sampling operator.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including the LAN or WAN, or the connection may be made to an external computer (for example, through the Internet using an Internet service provider).

The flowcharts and block diagrams in the accompanying drawings illustrate the architecture, functionality, and operation of possible implementations of systems, methods, and computer program products according to multiple embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under a circumstance.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, RAM, ROM, EPROM or flash memory, optical fiber, CD-ROM, optical storage device, magnetic storage device, or any suitable combination of the foregoing.

According to one or more embodiments of the present disclosure, [Example 1] provides a video processing method, which includes:
acquiring a video frame to be processed;
inputting the video frame to be processed into an image processing model to obtain a target video frame corresponding to the video frame to be processed, in which the image processing model includes an anti-aliasing operator for processing the video frame to be processed, and the anti-aliasing operator includes an anti-aliasing up-sampling operator, an anti-aliasing nonlinear operator, and an anti-aliasing down-sampling operator; and
obtaining a target video by splicing a plurality of target video frames.

According to one or more embodiments of the present disclosure, [Example 2] provides a video processing method, which further includes:
in response to the video frame to be processed being non-linearly processed based on the image processing model, sequentially processing the video frame to be processed based on the anti-aliasing up-sampling operator, the anti-aliasing nonlinear operator, and the anti-aliasing down-sampling operator in the anti-aliasing operators to obtain a target video frame having a target effect.

The target effect is consistent with the non-dithering effect.

According to one or more embodiments of the present disclosure, [Example 3] provides a video processing method, which further includes:
in response to detecting that the video frame to be processed is non-linearly processed, determining current tensor information corresponding to the video frame to be processed as an input to the anti-aliasing up-sampling operator, and interpolating the current tensor information based on the anti-aliasing up-sampling operator to obtain the first preprocessing tensor;
spreading signal spectrum corresponding to the first preprocessing tensor by at least two times based on the anti-aliasing nonlinear operator to obtain target signal spectrum corresponding to the first preprocessing image; and
down-sampling the target signal spectrum based on the anti-aliasing down-sampling operator, and controlling a down-sampling frequency to be a preset value of an original sampling frequency.

The original sampling frequency is consistent with a sampling frequency of a current tensor, and the preset value corresponds to a spreading factor of the signal spectrum.

According to one or more embodiments of the present disclosure, [Example 4] provides a video processing method, which further includes:
zero-inserting the current tensor information in a spatial dimension to obtain tensor information to be processed; and
interpolating the tensor information to be processed based on a convolution kernel constructed by an interpolation function to obtain the first preprocessing tensor.

According to one or more embodiments of the present disclosure, [Example 5] provides a video processing method, which further includes:
determining the anti-aliasing up-sampling operator, the anti-aliasing nonlinear operator, and the anti-aliasing down-sampling operator in the anti-aliasing operators, and deploying the anti-aliasing operators into an image processing model to be trained, in order to train the image processing model to be trained based on a plurality of training samples in a training sample set to obtain the image processing model.

According to one or more embodiments of the present disclosure, [Example 6] provides a video processing method, which further includes:
optimizing the anti-aliasing up-sampling operator in the anti-aliasing operator and maintaining the anti-aliasing nonlinear operator and the anti-aliasing down-sampling operator unchanged to obtain a target anti-aliasing operator, and deploying the target anti-aliasing operator in the image processing model to be trained; and
training the image processing model to be trained based on the training sample set to obtain the image processing model, in order to deploy the image processing model to a terminal device having computational power less than a preset computational power threshold.

According to one or more embodiments of the present disclosure, [Example 7] provides a video processing method, which further includes:
determining convolution kernels to be used based on an original sampling frequency, a cut-off frequency corresponding to the anti-aliasing down-sampling operator, a filtering frequency corresponding to a filter, an interpolation function, and a width of a preset window, in which the convolution kernels to be used include a plurality of values to be used;
determining two convolution kernels to be applied by separating the convolution kernels to be used; and
determining the anti-aliasing up-sampling operator based on the two convolution kernels to be applied.

According to one or more embodiments of the present disclosure, [Example 8] provides a video processing method, which further includes:
obtaining at least four convolution kernels to be deployed by combining the two convolution kernels to be applied, and determining the at least four convolution kernels to be deployed as the anti-aliasing up-sampling operator.

According to one or more embodiments of the present disclosure, [Example 9] provides a video processing method, which further includes:
processing current tensor information corresponding to the video frame to be processed based on the at least four convolution kernels to be deployed in the anti-aliasing up-sampling operator to obtain the first preprocessing tensor, so as to sequentially process the first preprocessing tensor based on the anti-aliasing nonlinear operator and the anti-aliasing down-sampling operator in the target anti-aliasing operator.

According to one or more embodiments of the present disclosure, [Example 10] provides a video processing apparatus, which includes a video frame to be processed acquiring module, a target video frame determining module, and a target video generating module.

The video frame to be processed acquiring module is configured to acquire a video frame to be processed.

The target video frame determining module is configured to input the video frame to be processed into an image processing model to obtain a target video frame corresponding to the video frame to be processed, in which the image processing model includes an anti-aliasing operator for processing the video frame to be processed, and the anti-aliasing operator includes an anti-aliasing up-sampling operator, an anti-aliasing nonlinear operator, and an anti-aliasing down-sampling operator.

The target video generating module is configured to obtain a target video by splicing a plurality of target video frames.

Furthermore, although the multiple operations are depicted in a particular order, it should not be understood as requiring that these operations be performed in the particular order as illustrated or in a sequential order. Under a certain circumstance, multitasking and parallel processing may be beneficial. Likewise, although multiple implementation details are contained in the above discussion, these should not be construed as limiting the scope of the present disclosure. Some features described in the context of separate embodiments can also be combined in a single embodiment. On the contrary, multiple features described in the context of a single embodiment can also be implemented in multiple embodiments separately or in any suitable sub-combination.

1. A video processing method, comprising:
acquiring a video frame to be processed;
inputting the video frame to be processed into an image processing model to obtain a target video frame corresponding to the video frame to be processed; wherein the image processing model comprises an anti-aliasing operator for processing the video frame to be processed, and the anti-aliasing operator comprises an anti-aliasing up-sampling operator, an anti-aliasing nonlinear operator, and an anti-aliasing down-sampling operator; and
obtaining a target video by splicing a plurality of target video frames.

2. The method of claim 1, wherein inputting the video frame to be processed into an image processing model to obtain a target video frame corresponding to the video frame to be processed, comprises:
in response to the video frame to be processed being non-linearly processed based on the image processing model, sequentially processing the video frame to be processed based on the anti-aliasing up-sampling operator, the anti-aliasing nonlinear operator, and the anti-aliasing down-sampling operator in the anti-aliasing operators to obtain a target video frame having a target effect;
wherein the target effect is consistent with a non-dithering effect.

3. The method of claim 2, wherein sequentially processing the video frame to be processed based on the anti-aliasing up-sampling operator, the anti-aliasing nonlinear operator, and the anti-aliasing down-sampling operator in the anti-aliasing operators, comprises:
in response to detecting that the video frame to be processed is non-linearly processed, determining current tensor information corresponding to the video frame to be processed as an input to the anti-aliasing up-sampling operator, and interpolating the current tensor information based on the anti-aliasing up-sampling operator to obtain a first preprocessing tensor;
spreading signal spectrum corresponding to the first preprocessing tensor by at least two times based on the anti-aliasing nonlinear operator to obtain target signal spectrum corresponding to a first preprocessing image; and
down-sampling the target signal spectrum based on the anti-aliasing down-sampling operator, and controlling a down-sampling frequency to be a preset value of an original sampling frequency;
wherein the original sampling frequency is consistent with a sampling frequency of a current tensor, and the preset value corresponds to a spreading factor of the signal spectrum.

4. The method of claim 3, wherein the interpolating the current tensor information based on the anti-aliasing up-sampling operator to obtain a first preprocessing tensor, comprises:
zero-inserting the current tensor information in a spatial dimension to obtain tensor information to be processed; and
interpolating the tensor information to be processed based on a convolution kernel constructed by an interpolation function to obtain the first preprocessing tensor.

5. The method of claim 1, further comprising:
determining the anti-aliasing up-sampling operator, the anti-aliasing nonlinear operator, and the anti-aliasing down-sampling operator in the anti-aliasing operators, and deploying the anti-aliasing operators into an image processing model to be trained, in order to train the image processing model to be trained based on a plurality of training samples in a training sample set to obtain the image processing model.

6. The method of claim 5, further comprising:
optimizing the anti-aliasing up-sampling operator in the anti-aliasing operator and maintaining the anti-aliasing nonlinear operator and the anti-aliasing down-sampling operator unchanged to obtain a target anti-aliasing operator, and deploying the target anti-aliasing operator in the image processing model to be trained; and
training the image processing model to be trained based on the training sample set to obtain the image processing model, in order to deploy the image processing model to a terminal device having computational power less than a preset computational power threshold.

7. The method of claim 6, wherein the optimizing the anti-aliasing up-sampling operator in the anti-aliasing operator, comprises:
determining convolution kernels to be used based on an original sampling frequency, a cut-off frequency corresponding to the anti-aliasing down-sampling operator, a filtering frequency corresponding to a filter, an interpolation function, and a width of a preset window;
wherein the convolution kernels to be used comprise a plurality of values to be used;
determining two convolution kernels to be applied by separating the convolution kernels to be used; and
determining the anti-aliasing up-sampling operator based on the two convolution kernels to be applied.

8. The method of claim 7, wherein determining the anti-aliasing up-sampling operator based on the two convolution kernels to be applied, comprises:
obtaining at least four convolution kernels to be deployed by combining the two convolution kernels to be applied, and determining the at least four convolution kernels to be deployed as the anti-aliasing up-sampling operator.

9. The method of claim 8, wherein processing the video frame to be processed based on the anti-aliasing operator comprises:
processing current tensor information corresponding to the video frame to be processed based on the at least four convolution kernels to be deployed in the anti-aliasing up-sampling operator to obtain a first preprocessing tensor; and
sequentially processing the first preprocessing tensor based on the anti-aliasing nonlinear operator and the anti-aliasing down-sampling operator in the target anti-aliasing operator.

10. (canceled)

11. An electronic device, comprising:
at least one processor;
a storage apparatus, configured to store at least one program,
wherein when the at least one program is executed by the at least one processor, the at least one processor is configured to:
acquire a video frame to be processed;
input the video frame to be processed into an image processing model to obtain a target video frame corresponding to the video frame to be processed; wherein the image processing model comprises an anti-aliasing operator for processing the video frame to be processed, and the anti-aliasing operator comprises an anti-aliasing up-sampling operator, an anti-aliasing nonlinear operator, and an anti-aliasing down-sampling operator; and
obtain a target video by splicing a plurality of target video frames.

12. A non-transitory storage medium comprising computer-executable instructions, wherein when executed by a computer processor, the computer-executable instructions are used to
acquire a video frame to be processed;
input the video frame to be processed into an image processing model to obtain a target video frame corresponding to the video frame to be processed; wherein the image processing model comprises an anti-aliasing operator for processing the video frame to be processed, and the anti-aliasing operator comprises an anti-aliasing up-sampling operator, an anti-aliasing nonlinear operator, and an anti-aliasing down-sampling operator; and
obtain a target video by splicing a plurality of target video frames.

13. (canceled)

14. The electronic device of claim 11, wherein the at least one processor is further configured to:
in response to the video frame to be processed being non-linearly processed based on the image processing model, sequentially process the video frame to be processed based on the anti-aliasing up-sampling operator, the anti-aliasing nonlinear operator, and the anti-aliasing down-sampling operator in the anti-aliasing operators to obtain a target video frame having a target effect;
wherein the target effect is consistent with a non-dithering effect.

15. The electronic device of claim 14, wherein the at least one processor is further configured to:
in response to detecting that the video frame to be processed is non-linearly processed, determine current tensor information corresponding to the video frame to be processed as an input to the anti-aliasing up-sampling operator, and interpolate the current tensor information based on the anti-aliasing up-sampling operator to obtain a first preprocessing tensor;
spread signal spectrum corresponding to the first preprocessing tensor by at least two times based on the anti-aliasing nonlinear operator to obtain target signal spectrum corresponding to a first preprocessing image; and
down-sample the target signal spectrum based on the anti-aliasing down-sampling operator, and control a down-sampling frequency to be a preset value of an original sampling frequency;
wherein the original sampling frequency is consistent with a sampling frequency of a current tensor, and the preset value corresponds to a spreading factor of the signal spectrum.

16. The electronic device of claim 15, wherein the at least one processor is further configured to:
zero-insert the current tensor information in a spatial dimension to obtain tensor information to be processed; and
interpolate the tensor information to be processed based on a convolution kernel constructed by an interpolation function to obtain the first preprocessing tensor.

17. The electronic device of claim 11, wherein the at least one processor is further configured to:
determine the anti-aliasing up-sampling operator, the anti-aliasing nonlinear operator, and the anti-aliasing down-sampling operator in the anti-aliasing operators, and deploy the anti-aliasing operators into an image processing model to be trained, in order to train the image processing model to be trained based on a plurality of training samples in a training sample set to obtain the image processing model.

18. The electronic device of claim 17, wherein the at least one processor is further configured to:
optimize the anti-aliasing up-sampling operator in the anti-aliasing operator and maintaining the anti-aliasing nonlinear operator and the anti-aliasing down-sampling operator unchanged to obtain a target anti-aliasing operator, and deploy the target anti-aliasing operator in the image processing model to be trained; and
train the image processing model to be trained based on the training sample set to obtain the image processing model, in order to deploy the image processing model to a terminal device having computational power less than a preset computational power threshold.

19. The electronic device of claim 18, wherein the at least one processor is further configured to:
determine convolution kernels to be used based on an original sampling frequency, a cut-off frequency corresponding to the anti-aliasing down-sampling operator, a filtering frequency corresponding to a filter, an interpolation function, and a width of a preset window; wherein the convolution kernels to be used comprise a plurality of values to be used;
determine two convolution kernels to be applied by separating the convolution kernels to be used; and
determine the anti-aliasing up-sampling operator based on the two convolution kernels to be applied.

20. The electronic device of claim 19, wherein the at least one processor is further configured to:
obtain at least four convolution kernels to be deployed by combining the two convolution kernels to be applied, and determine the at least four convolution kernels to be deployed as the anti-aliasing up-sampling operator.

21. The electronic device of claim 20, wherein the at least one processor is further configured to:
process current tensor information corresponding to the video frame to be processed based on the at least four convolution kernels to be deployed in the anti-aliasing up-sampling operator to obtain a first preprocessing tensor; and
sequentially process the first preprocessing tensor based on the anti-aliasing nonlinear operator and the anti-aliasing down-sampling operator in the target anti-aliasing operator.

22. The non-transitory storage medium of claim 12, wherein the computer-executable instructions are further used to:
in response to the video frame to be processed being non-linearly processed based on the image processing model, sequentially process the video frame to be processed based on the anti-aliasing up-sampling operator, the anti-aliasing nonlinear operator, and the anti-aliasing down-sampling operator in the anti-aliasing operators to obtain a target video frame having a target effect;
wherein the target effect is consistent with a non-dithering effect.
